(19) United States
(12) Patent Application Publication
(10) Pub. No.: US 2024/0265735 A1
(43) Pub. Date: Aug. 8, 2024

(54) GUIDING METHOD AND APPARATUS FOR PALM VERIFICATION, TERMINAL, STORAGE MEDIUM, AND PROGRAM PRODUCT

(71) Applicant: Tencent Technology (Shenzhen) Company Limited, Shenzhen (CN)

(72) Inventors: Yafei Yuan, Shenzhen (CN); Wen Ge, Shenzhen (CN); Lulu Jiao, Shenzhen (CN); Jiayu Huang, Shenzhen (CN); Runzeng Guo, Shenzhen (CN); Ruixin Zhang, Shenzhen (CN); Yingyi Zhang, Shenzhen (CN); Hang Zhou, Shenzhen (CN); Jun Wang, Shenzhen (CN)

(21) Appl. No.: 18/626,151

(22) Filed: Apr. 3, 2024

Related U.S. Application Data
(63) Continuation of application No. PCT/CN2023/094684, filed on May 17, 2023.

(30) Foreign Application Priority Data
Jul. 18, 2022 (CN) 202210840599.4

(51) Int. Cl. G06V 40/60; G06V 10/74; G06V 40/12; G06V 40/13

(52) U.S. Cl. CPC G06V 40/67; G06V 10/761; G06V 40/1318; G06V 40/1365

(57) ABSTRACT

A method for guiding palm verification performed by a computer device is disclosed. The method includes: displaying a guidance interface for palm verification, the guidance interface including graphical guidance information and the graphical guidance information comprising a movable element in a moving region, and a display location of the movable element in the moving region indicating a current distance between a palm and a detection device; dynamically adjusting the display location of the movable element in the moving region on the guidance interface in response to a change of the current distance between the palm and the detection device; and displaying first prompt information for indicating starting of verification or completion of verification when the display location of the movable element in the moving region meets a preset condition.

### CROSS-REFERENCE TO RELATED APPLICATIONS

This application is a continuation application of PCT Patent Application No. PCT/CN2023/094684, entitled “GUIDING METHOD AND APPARATUS FOR PALM VERIFICATION, TERMINAL, STORAGE MEDIUM, AND PROGRAM PRODUCT” filed on May 17, 2023, which claims priority to Chinese Patent Application No. 202210840599.4, entitled “GUIDING METHOD AND APPARATUS FOR PALM VERIFICATION, TERMINAL, STORAGE MEDIUM, AND PROGRAM PRODUCT” filed on Jul. 18, 2022, all of which is incorporated herein by reference in its entirety.

This application relates to U.S. patent application Ser. No. ______, entitled “PALM IMAGE RECOGNITION METHOD AND APPARATUS, DEVICE, STORAGE MEDIUM, AND PROGRAM PRODUCT” filed on xxx, (Attorney Docket No. 031384-8022-US), which is incorporated herein by reference in its entirety.

This application relates to U.S. patent application Ser. No. 18/431,821, entitled “IMAGE ACQUISITION METHOD AND APPARATUS, COMPUTER DEVICE, AND STORAGE MEDIUM” filed on Feb. 2, 2024, which is incorporated herein by reference in its entirety.

### FIELD OF THE TECHNOLOGY

Embodiments of this application relate to the field of computer technologies, and in particular, to a guiding method and apparatus for palm verification, a terminal, a storage medium, and a program product.

### BACKGROUND OF THE DISCLOSURE

With development of computer technologies, palm verification is used in an increasing number of application scenarios, such as palm verification for door unlocking, palm verification for payment, and palm verification for clock-in/clock-out.

Palm verification for door unlocking is used as an example. In the related art, during palm verification, a user is guided to control a palm to complete a specified moving track and make an authentication gesture to complete palm verification for door unlocking. In this solution, an operation of palm verification is complex, and efficiency of palm verification is low.

### SUMMARY

Embodiments of this application provide a guiding method and apparatus for palm verification, a terminal, a storage medium, and a program product, to improve efficiency of palm verification. The technical solutions may include the following content:

According to an aspect of the embodiments of this application, a method for guiding palm verification is provided, the method being performed by a computer device, and the method including:
displaying a guidance interface for palm verification, the guidance interface including graphical guidance information and the graphical guidance information comprising a movable element in a moving region, and a display location of the movable element in the moving region indicating a current distance between a palm and a detection device;
dynamically adjusting the display location of the movable element in the moving region on the guidance interface in response to a change of the current distance between the palm and the detection device; and
displaying first prompt information for indicating starting of verification or completion of verification when the display location of the movable element in the moving region meets a preset condition.

According to an aspect of the embodiments of this application, a computer device is provided, the terminal device including a processor and a memory, the memory storing a computer program, and the computer program being loaded and executed by the processor to cause the computer device to implement the foregoing method for guiding palm verification.

According to an aspect of the embodiments of this application, a non-transitory computer-readable storage medium is provided, the readable storage medium storing a computer program, and the computer program being loaded and executed by a processor of a computer device to cause the computer device to implement the foregoing method for guiding palm verification.

The technical solutions provided in the embodiments of this application include at least the following beneficial effect:

The distance between the palm and the detection device is indicated by the display location of the movable element in the moving region, and the display location of the movable element in the moving region is dynamically adjusted on the guidance interface in response to a change of the distance. In this way, visual guidance for palm verification can be completed based only on the distance between the palm and the detection device. This reduces complexity of palm verification and therefore improves efficiency of palm verification.

In addition, in the embodiments of this application, the user only needs to be guided to adjust the distance between the palm and the detection device. This reduces costs of understanding by the user during palm verification, and therefore improves user experience during palm verification.

### BRIEF DESCRIPTION OF THE DRAWINGS

FIG. 1 is a schematic diagram of a solution implementation environment according to an embodiment of this application.

FIG. 2 is a schematic diagram of a detection device according to an embodiment of this application.

FIG. 3 is a schematic diagram of a method for guiding palm verification according to an embodiment of this application.

FIG. 4 is a schematic diagram of a guidance interface in an initial state according to an embodiment of this application.

FIG. 5 to FIG. 9 are schematic diagrams of changes of a guidance interface during palm verification.

FIG. 10 is a schematic diagram of a method for obtaining a palm swipe distance according to an embodiment of this application.

FIG. 11 is a schematic diagram of a palm detection plane according to an embodiment of this application.

FIG. 12 is a schematic diagram of a method for obtaining a palm bounding box according to an embodiment of this application.

FIG. 13 is a schematic diagram of a palm detection method according to an embodiment of this application.

FIG. 14 is a schematic diagram of a palm detection model according to an embodiment of this application.

FIG. 15 is a schematic diagram of an offset obtaining method according to an embodiment of this application.

FIG. 16 is a block diagram of a guiding apparatus for palm verification according to an embodiment of this application.

FIG. 17 is a block diagram of a guiding apparatus for palm verification according to another embodiment of this application.

FIG. 18 is a schematic structural diagram of a terminal device according to an embodiment of this application.

### DESCRIPTION OF EMBODIMENTS

To make the objectives, technical solutions, and advantages of this application clearer, the following further describes implementations of this application in detail with reference to the accompanying drawings.

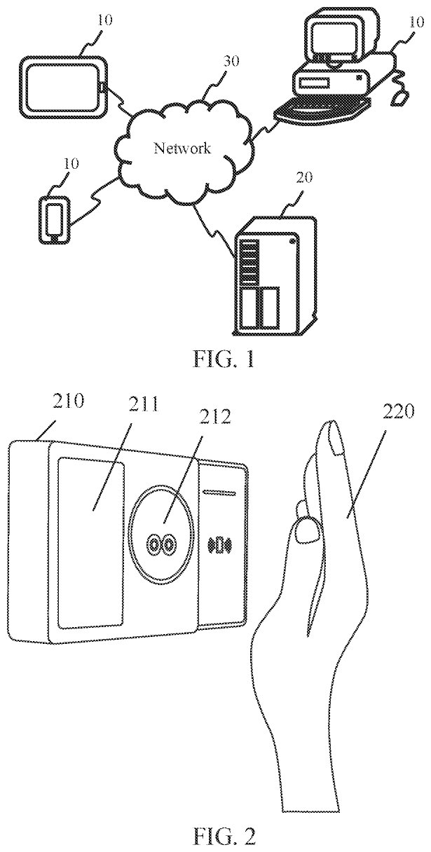

FIG. 1 is a schematic diagram of a solution implementation environment according to an embodiment of this application. The implementation environment may include a terminal device 10 and a server 20.

The terminal device 10 may be a mobile phone, a tablet computer, a multimedia playback device, a personal computer (PCS), an intelligent robot, a vehicle-mounted terminal, an access control device, a payment device, a security check device, or any electronic device with an image obtaining function. A client for a target application, for example, a client for a palm verification application, a payment application, a social entertainment application, or a simulation learning application, may be installed on the terminal device 10.

The server 20 is configured to provide a background service for the client of the target application (for example, the palm verification application) on terminal device 10. For example, the server 20 may be a back-end server for the foregoing application (for example, the palm verification application). The server 20 may be one server, a server cluster including a plurality of servers, or a cloud computing service center.

The terminal device 10 and the server 20 may communicate with each other through a network 30. The network 30 may be a wired network or a wireless network.

For example, as shown in FIG. 2, a client for a target application (for example, a palm verification application) is installed and run on a detection device 210, and the detection device 210 includes a display screen 211 and a palm detection plane 212. A guidance interface for palm verification is displayed on the display screen 211. Graphical guidance information is displayed on the guidance interface, and the graphical guidance information includes a movable element and a moving region corresponding to the movable element. A display location of the movable element in the moving region is used for indicating a distance between a palm and a detection device. The client dynamically adjusts the display location of the movable element in the moving region on the guidance interface in response to a change of the distance. The client displays first prompt information for indicating starting of verification or completion of verification when the display location of the movable element in the moving region meets a preset condition.

In some embodiments, a camera is disposed on the palm detection plane 212 to obtain an image of the palm. The image of the palm may be used for obtaining the distance between the palm 220 and the detection device 210, and recognizing and verifying the palm 220.

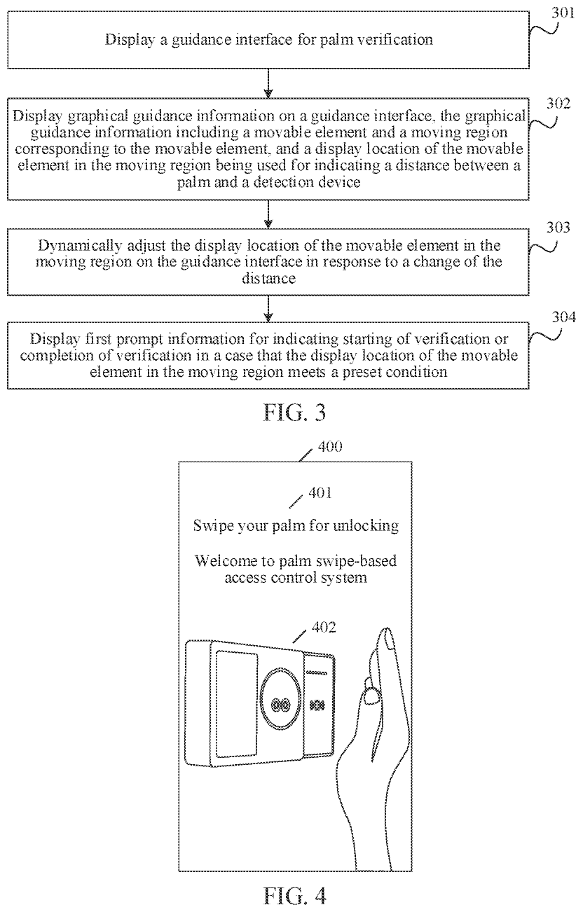

FIG. 3 is a flowchart of a method for guiding palm verification according to an embodiment of this application. Steps of the method may be performed by the terminal device 10, for example, by the client on the terminal device 10, in the solution implementation environment shown in FIG. 1. The method may include the following steps (301 to 304):

Step 301: Display a guidance interface for palm verification.

Palm verification is a process of recognizing and verifying a palm image. For example, the client recognizes a palmprint feature, a palm vein image, a palm swipe track, and the like in the palm image to obtain a recognition result, and then compares the recognition result with a palmprint feature, a palm vein image, a palm swipe track, and the like stored in a verification system to implement palm verification.

The guidance interface is an interface for guiding a user to perform palm verification. The guidance interface may be a display interface corresponding to the foregoing target application, for example, the palm verification application, the payment application, the social entertainment application, or the simulation learning application.

In an example, a detection device corresponding to the palm verification may include a display screen and a palm detection plane. The display screen is configured to display a guidance interface corresponding to the target application. The palm detection plane is configured to obtain palm-related information such as a palm image, a palm swipe track, a palm swipe distance, and a palm swipe height.

In some embodiments, the display screen of the guidance interface does not overlap the palm detection plane of the detection device. For example, the display screen and the palm detection plane may be disposed in parallel, or the display screen and the palm detection plane may be disposed in a staggered manner. This is not limited in this embodiment of this application. For example, as shown in FIG. 2, the display screen 211 and the palm detection plane 212 may be disposed in a left-right distribution manner. In this way, visibility of the guidance interface is not affected during palm verification, so that the user can obtain guidance information provided by the guidance interface. This avoids a problem that the guidance information is blocked during palm verification when the display screen is disposed under the palm detection plane, and therefore reduces difficulty of obtaining the guidance information by the user, improves convenience of palm verification, and improves user experience during palm verification.

In an example, the detection device is configured to detect a palm in a contactless manner, and the contactless manner means that the palm is not in contact with the palm detection plane of the detection device. For example, the detection device has a detection region, and the detection region may be a region within which the detection device can obtain a palm image. For example, a range of the detection region may be determined based on a shooting range of a camera corresponding to the detection device, and the user may place a palm in the detection region to perform palm verification. Palm verification is performed in the contactless manner, so that contact between the user and the detection device (for example, tapping the display screen) can be avoided. This reduces a risk of palm verification and therefore improves security of palm verification.

For example, as shown in FIG. 4, palm verification for door unlocking is used as an example. Second prompt information for guiding the user to perform an operation that needs to be performed is displayed on an initial guidance interface 400. For example, the second prompt information is prompt information “Swipe your palm for unlocking” 401 in a text form and prompt information 402 in a graphical form. The prompt information 402 is used for prompting the user to perform non-contact palm verification with the palm detection plane of the detection device.

Step 302: Display graphical guidance information on the guidance interface, the graphical guidance information including a movable element and a moving region corresponding to the movable element, and a display location of the movable element in the moving region being used for indicating a distance between a palm and a detection device.

In some embodiments, the client performs a palm swipe guiding stage in response to a palm swipe operation performed by the user, and graphical guidance information is displayed on a guidance interface corresponding to the client. For example, the graphical guidance information may be displayed on the guidance interface in response to placing, by the user, the palm in a detection region corresponding to the detection device. The graphical guidance information guides, in a graphical form, the user to adjust the distance between the palm and the detection device to complete palm verification.

The distance between the palm and the detection device may also be referred to as a palm swipe distance, a palm swipe height, or the like. For example, the palm swipe height may more intuitively indicate a relationship between the palm and the detection device when the detection device is disposed horizontally.

The moving region corresponding to the movable element is a range on the guidance interface within which the movable element is capable of moving. The movable element may be used for representing the palm. The moving region corresponding to the movable element is a physical mapping of a range of the distance between the palm and the detection device. The display location of the movable element in the moving region may be used for indicating the distance between the palm and the detection device. A correspondence is established between the palm swipe height and a single element in the graphical guidance information, and the distance between the palm and the detection device is physically mapped to the graphical guidance information. This helps the user understand a real-time palm swipe height, and therefore improves user experience during palm verification. Compared with providing guidance on a location between the palm and the detection device, operation difficulty of palm verification in this embodiment of this application is lower, so that efficiency of palm verification is improved.

The display location of the movable element in the moving region changes with the distance between the palm and the detection device.

In an example, the graphical guidance information further includes a marked element displayed in the moving region, a display location of the marked element in the moving region being used for indicating a target distance or a target distance range between the palm and the detection device. The marked element provides reference for the user to adjust a location of the palm. This facilitates visual guidance for the user to swipe the palm.

The marked element is used for indicating an appropriate distance between the palm and the detection device, or may be used for indicating a final distance between the palm and the detection device. This is not limited in this embodiment of this application. The target distance or the target distance range is the appropriate distance or the final distance between the palm and the detection device.

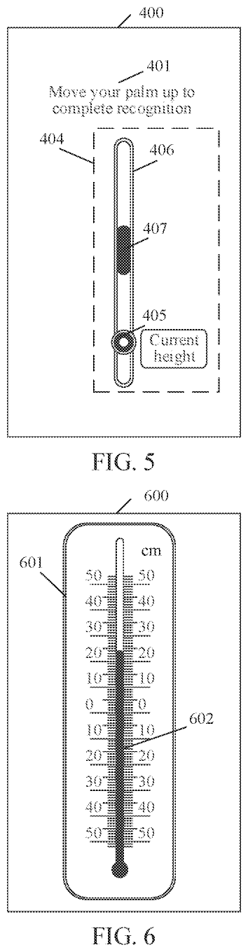

For example, as shown in FIG. 5, in response to starting palm verification by the user, graphical guidance information 404 is displayed on the guidance interface 400, and the graphical guidance information 404 includes a movable element 405, a moving region 406 corresponding to the movable element 405, and a marked element 407. The moving region 406 is a bar region, and different locations in the moving region 406 correspond to different distances. A display location of the movable element 405 in the moving region 406 is used for indicating a current distance between the palm and the detection device. A display location of the marked element 407 in the moving region is used for indicating a target distance or a target distance range, between the palm and the detection device, to which the user needs to perform adjustment. In addition, a function of the prompt information 401 is adjusted to be guiding the user to adjust the palm. For example, the prompt information 401 is displayed in a text form: “Move your palm up to complete recognition”.

In some embodiments, the moving region corresponds to a numerical mark, and the numerical mark is a true distance between the palm and the detection device or a physical mapping of the true distance. For example, as shown in FIG. 6, graphical guidance information 601 is displayed on a guidance interface 600, the graphical guidance information 601 corresponds to a numerical mark, and a numerical mark corresponding to a display location of a movable element 602 in the moving region indicates that the current distance between the palm and the detection device is 24 cm.

Step 303: Dynamically adjust the display location of the movable element in the moving region on the guidance interface in response to a change of the distance.

In some embodiments, in response to an increase of the distance between the palm and the detection device, a picture in which the movable element moves toward a highest location in the moving region is displayed on the guidance interface; or in response to a decrease of the distance between the palm and the detection device, a picture in which the movable element moves toward a lowest location in the moving region is displayed on the guidance interface.

For example, as shown in FIG. 5, in response to movement of the palm away from the detection device, a picture in which the movable element 405 moves toward a highest location in the moving region 406 is displayed on the guidance interface 400, so that the movable element 405 moves close to the marked element 407.

For another example, as shown in FIG. 6, a numerical mark corresponding to a marked element is set to 0. The 0 indicates a target distance under a physical mapping corresponding to an appropriate distance. A numerical mark above the marked element is used for indicating that the palm is located in a detection region greater than the appropriate distance. A numerical mark below the marked element is used for indicating that the palm is located in a detection region between the appropriate distance and the detection device. In response to movement of the palm away from the appropriate distance corresponding to the marked element, the guidance interface 600 displays that the movable element 602 moves away from the marked element.

Step 304: Display first prompt information for indicating starting of verification or completion of verification when the display location of the movable element in the moving region meets a preset condition.

The preset condition is a preset verification condition for determining starting of verification or completion of verification. In a case that the display location of the movable element in the moving region meets the preset condition, it can be determined that verification has started or verification is completed. A specific preset condition is not limited in this application. As described below, this application provides examples of two preset conditions.

The palm may be guided to an appropriate height before verification is started, or verification may be performed during movement of the palm. This is not limited in this embodiment of this application.

In an example, the first prompt information for indicating starting of verification or completion of verification is displayed when the display location of the movable element in the moving region matches the display location of the marked element in the moving region.

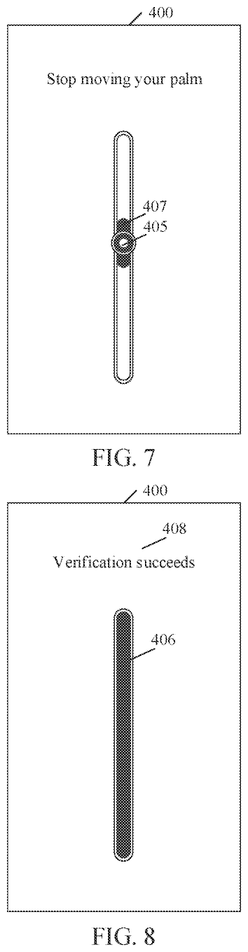

For example, as shown in FIG. 7 and FIG. 8, first prompt information 408 for indicating completion of verification is displayed on the guidance interface 400 when the display location of the movable element 405 matches the display location of the marked element 407. The matching may mean that a numerical mark corresponding to the display location of the movable element 405 is the same as a numerical mark corresponding to the display location of the marked element 407, or the matching may mean that a numerical mark corresponding to the display location of the movable element 405 falls within a numerical mark range corresponding to the display location of the marked element 407. In addition, the second prompt information is used for prompting the user to stop moving the palm.

In some embodiments, when the palm verification succeeds, the moving region may be highlighted to indicate, to the user, that the palm verification succeeds. For example, as shown in FIG. 8, the moving region 406 is filled. A same element is used for completing a transition of guidance information. This improves fluency of subjective understanding by the user.

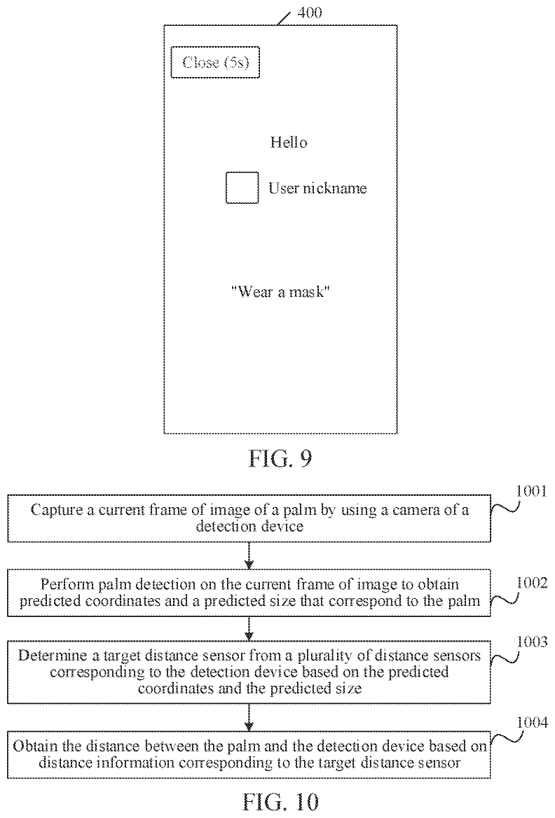

In some embodiments, after the palm verification succeeds, the display of the graphical guidance information is canceled, and a user interaction interface, a door unlocking success interface, a payment success interface, a clock-in/clock-out success interface, or the like, and user-related information are displayed. For example, as shown in FIG. 9, after the display of the graphical guidance information is canceled, a user nickname, a user image, prompt information, and the like are displayed on the guidance interface 400.

In another example, there are a plurality of marked elements, and different marked elements correspond to different target distances or target distance ranges. The first prompt information for indicating starting of verification or completion of verification is displayed when the display location of the movable element in the moving region matches display locations of the plurality of marked elements in the moving region in a target order. The target order is a matching order of the plurality of marked elements.

For example, it is assumed that three marked elements appear in sequence: A, B, and C. A, B, and C respectively correspond to different target distances or target distance ranges, and the target order is A, B, and C. A is first displayed on the guidance interface. In a case that the display location of the movable element in the moving region matches a display location of A in the moving region, B is displayed on the guidance interface. The user adjusts the palm to change the display location in the moving region. In a case that the display location of the movable element in the moving region matches a display location of B in the moving region, C is displayed on the guidance interface. The user continues to adjust the palm to change the display location in the moving region. In a case that the display location of the movable element in the moving region matches a display location of C in the moving region, the first prompt information for indicating starting of verification or completion of verification is displayed on the guidance interface.

In some embodiments, when prompt information related to the target order is displayed on the guidance interface, an image of the palm is captured by using the camera of the detection device when the movable element matches each marked element. The palm is recognized and verified based on a plurality of images of the palm that are captured at different distances to obtain a verification result.

To be specific, the palm is recognized and verified sequentially within a plurality of target distances or target distance ranges to obtain a plurality of verification results. In a case that the plurality of verification results all indicate success, it can be determined that the palm verification succeeds.

For example, in this case, overall feature information and local feature information of the palm may alternatively be captured separately based on a plurality of marked elements. For example, the palm may be first guided to move away from the detection device to capture an overall image of the palm, then the palm is guided to move close to the detection device to capture a local image of the palm, and then the overall feature information and the local feature information of the palm are obtained to complete identity verification for the user corresponding to the palm. Compared with identity verification based only on the overall feature information or the local feature information of the palm, security of palm verification can be improved in the technical solution provided in this embodiment of this application.

In some embodiments, when no prompt information related to the target order is displayed on the guidance interface, the first prompt information for indicating starting of verification is displayed when the display location of the movable element in the moving region matches the display locations of the plurality of marked elements in the moving region in the target order. An image of the palm is captured by using the camera of the detection device. The palm is recognized and verified based on the image of the palm to obtain a verification result. For example, the palm is guided to a location at an appropriate distance from the detection device through sequential matching with the plurality of marked elements, and then the palm is recognized and verified to obtain the verification result.

Alternatively, first prompt information for indicating completion of verification is displayed when the display location of the movable element in the moving region matches the display locations of the plurality of marked elements in the moving region in the target order. For example, the palm may be recognized and verified separately at the plurality of marked elements, or the palm may be recognized and verified during movement of the palm, so that the verification result can be directly displayed when matching with a last marked element is completed during palm verification. This can reduce complexity of palm verification and further improve efficiency of palm verification.

In this scenario, the target order may be understood as a password, and verification can succeed only when the user knows the “password” and performs triggering in order. In addition, in this case, palm verification can be completed without recognizing or verifying the palm to confirm an identity of the user during movement of the palm. Alternatively, the palm may be recognized and verified during movement of the palm to implement double verification based on the “password” and a “palmprint”. This improves security of palm verification.

In an example, the palm verification includes first-stage verification and second-stage verification, the stage of first-stage verification is completed by a first palm of the user, the stage of second-stage verification is completed by a second palm of the user, and the first palm is different from the second palm. The movable element moves along a first specified track by following a distance between the first palm and the detection device to complete the first-stage verification, and the movable element moves along a second specified track by following a distance between the second palm and the detection device to complete the second-stage verification. The first specified track or the second specified moving track may be a combination of moving away from the detection device, moving close to the detection device, moving away from the detection device, and moving close to the detection device, or the like.

For example, two pieces of graphical guidance information may be displayed on the guidance interface, one being used for guiding a left palm of the user to perform palm verification, and the other being used for guiding a right palm of the user to perform palm verification. The first prompt information for indicating starting of verification or completion of verification is displayed when both the first-stage verification and the second-stage verification are completed. Alternatively, one piece of graphical guidance information may be displayed on the guidance interface, the graphical guidance information being used for guiding the left palm of the user to perform palm verification. In a case that the verification on the left palm succeeds, another piece of graphical guidance information is displayed, the graphical guidance information being used for guiding the right palm of the user to perform palm verification. In a case that the verification on the right palm succeeds, the first prompt information for indicating starting of verification or completion of verification is displayed. This can implement joint verification on the left palm and the right palm and therefore improve security of palm verification.

In an example, third prompt information is displayed in response to that the palm moves out of a verification region corresponding to the detection device, the third prompt information being used for prompting the user to perform palm verification again. To be specific, during palm verification, when the detection device cannot capture an image of the palm, the user needs to be prompted to move the palm back to the detection region and start palm verification again.

To sum up, in the technical solution provided in this embodiment of this application, the distance between the palm and the detection device is indicated by the display location of the movable element in the moving region, and the display location of the movable element in the moving region is dynamically adjusted on the guidance interface in response to a change of the distance. In this way, visual guidance for palm verification can be completed based only on the distance between the palm and the detection device. This reduces complexity of palm verification and therefore improves efficiency of palm verification.

In addition, in this embodiment of this application, the user only needs to be guided to adjust the distance between the palm and the detection device. This reduces costs of understanding by the user during palm verification, and therefore improves user experience during palm verification.

In addition, in this embodiment of this application, the overall feature information and the local feature information of the palm are combined based on the plurality of marked elements to complete palm verification. This improves security of palm verification.

In addition, in this embodiment of this application, palm verification is completed based on a combination of the left palm and the right palm of the user. This improves security of palm verification.

Before a method process in this application is performed, first information for asking whether the user agrees to capture a palm image and perform palm verification is displayed on the terminal device, and a first option and a second option are displayed. A related method process in this application is performed after the user selects the first option. The first option is used for representing consent to capture a palm image, and the second option is used for representing rejection to capture a palm image. Display content of the first information, the first option, and the second option is not limited in this application. For example, the first information may be displayed as follows: “A palm image must be captured for palm verification”; or may be displayed as follows: “A palm image must be captured to enable the palm verification function”. The first option and the second option may be displayed as “Agree” and “Disagree”, or may be displayed as “OK” and “Cancel”.

The method for guiding palm verification is described in detail above. A method for obtaining a distance between a palm and a detection device is described in detail below.

FIG. 10 is a flowchart of a method for obtaining a palm swipe distance according to an embodiment of this application. Steps of the method may be performed by the terminal device 10, for example, by the client on the terminal device 10, in the solution implementation environment shown in FIG. 1. The method may include the following steps (1001 to 1004):

Step 1001: Capture a current frame of image of a palm by using a camera of a detection device.

During palm verification, the camera of the detection device captures the palm in real time to obtain a palm image. The current frame of image is a palm image at a current moment. A description of the detection device is the same as that in the foregoing embodiment. For a part not described in this embodiment of this application, refer to the foregoing embodiment. Details are not described herein again.

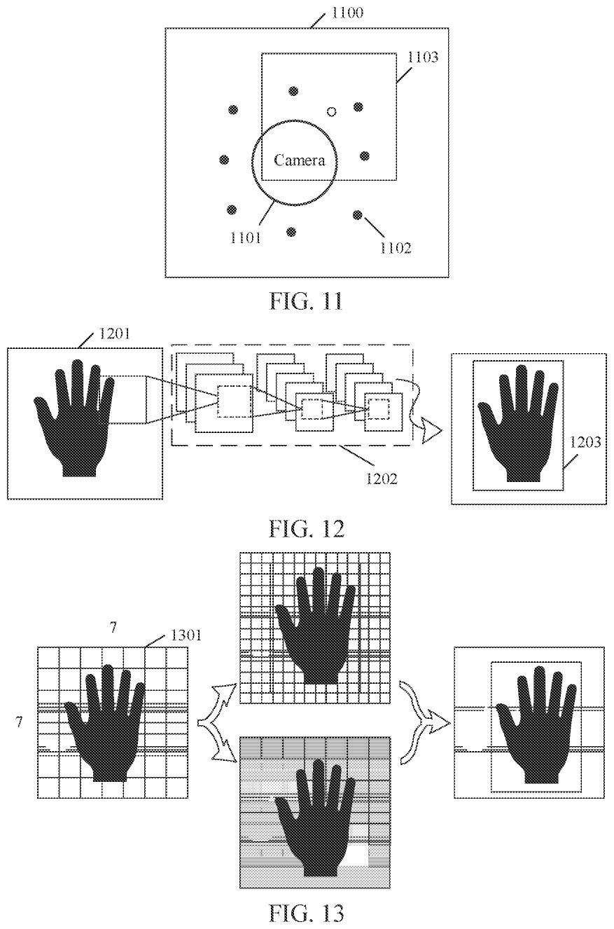

For example, as shown in FIG. 11, a camera 1101 and a plurality of distance sensors 1102 are disposed on a palm detection plane 1100 of the detection device, and the plurality of distance sensors 1102 may be symmetrically distributed with the camera as a center of a circle. The camera 1101 may capture the current frame of image of the palm, and the distance sensor 1102 may obtain a distance between the palm and the detection device. In some feasible embodiments, the camera 1101 is a depth camera, and may obtain both a color image and a depth image of the palm, and then obtain the distance between the palm and the detection device by using an algorithm.

Step 1002: Perform palm detection on the current frame of image to obtain predicted coordinates and a predicted size that correspond to the palm.

The predicted coordinates are used for representing a location of the palm in the current frame of image. The predicted size is used for representing a size of the palm in the current frame of image.

To measure a palm swipe distance, a distance sensor is used to detect the palm swipe distance in this embodiment of this application. However, because the distance sensor is only used to test the palm swipe distance, in a complex scenario (for example, an arm of the user blocks the distance sensor), measurement on the palm swipe distance that is performed only by the distance sensor leads to inaccurate determining on a distance. This further leads to incorrect guidance for palm verification. Based on this, in this embodiment of this application, a distance estimation method based on palm location detection and the distance sensor is used to improve accuracy of measurement on the palm swipe distance, to improve accuracy of guidance for palm verification.

In an example, palm detection may be performed on the current frame of image by using a palm detection model to obtain the predicted coordinates and the predicted size that correspond to the palm. The palm detection model may be constructed based on a single shot detector (SSD, an object detection network); or may be constructed based on another detection network, for example, you only look once (YOLO, an object detection network), a convolutional neural network (CNN), a region-based CNN (R-CNN), or a faster R-CNN. This is not limited in this embodiment of this application. The palm detection model may be obtained through training based on sample data that carries a palm box annotation.

For example, as shown in FIG. 12, first, a current frame of image 1201 is input to a palm detection model 1202, and the palm detection model 1202 divides the current frame of image 1201 into S×S grids, and then predicts B bounding boxes for each grid. Each bounding box includes five predicted values: x, y, w, h, and a confidence. x and y are coordinates of a center point of the bounding box. w and h are sizes of the bounding box.

The confidence is used for representing a possibility that the bounding box includes the palm. For example, when probabilities of C hypothetical categories are predicted for each grid (in this embodiment of this application, only a probability of a palm category needs to be predicted), a prediction result of the model is a tensor of S×S×(B×5+C).

For example, as shown in FIG. 13, a current frame of image 1301 is divided into 7×7 grids, that is, S=7, and each grid corresponds to two bounding boxes, that is, B=2. Assuming that there are a total of 20 hypothetical categories, that is, C=20, a prediction result of the model is a tensor of 7×7×30.

In some embodiments, a calculation formula for the confidence may be as follows: Pr*IOU_{perd}^{truth}, where Pr is used for indicating whether a corresponding grid includes an object (when the corresponding grid includes the object, Pr=1; or when the corresponding grid does not include the object, Pr=0), and IOU_{pred}^{truth} is an intersection of union between a palm bounding box output by the palm detection model and a real palm bounding box. In a case that the grid does not include the object, the confidence is 0. In a case that the grid includes the object, the confidence is the intersection of union between the palm bounding box output by the palm detection model and the real palm bounding box.

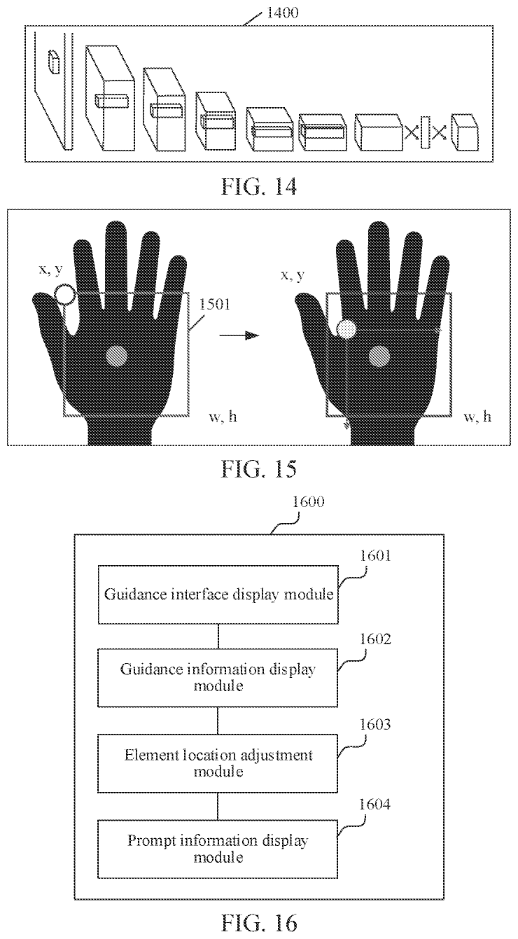

In some embodiments, the palm detection model is mainly GoogleNet (a deep learning network). For example, as shown in FIG. 14, a palm detection model 1400 includes a convolutional layer and a fully connected layer. The convolutional layer is configured to extract a feature of a current image frame. The fully connected layer is configured to predict a category, coordinates, a size, a confidence, and the like based on the feature output by the convolutional layer.

In an example, because a hypothetical category of the palm detection model is only the palm, a bounding box with a highest confidence may be determined as a palm bounding box (for example, a palm bounding box 1203 in FIG. 12), a center point or a corner point of the palm bounding box is determined as the predicted coordinates of the palm, and a size of the palm bounding box is determined as the predicted size of the palm. The location of the palm in the current frame of image may be determined based on the predicted coordinates and the predicted size.

After the predicted coordinates and the predicted size are obtained, the predicted coordinates may be aligned with a grid corresponding to the palm bounding box (based on an offset relative to the grid), so that a range of the predicted coordinates is adjusted to 0-1. In addition, the predicted size may also be normalized. For example, w and h are divided by a width and a height of the current frame of image respectively, so that ranges of w and h are adjusted to 0-1.

Step 1003: Determine a target distance sensor from a plurality of distance sensors corresponding to the detection device based on the predicted coordinates and the predicted size.

The distance sensor is configured to obtain a true distance between the palm and the detection device. A coordinate system is constructed with the camera of the detection device as an origin, and the target distance sensor may be determined based on a target quadrant of the palm in the coordinate system. In an example, a process of determining the target distance sensor may be as follows:

1. A palm center of the palm is determined based on the predicted coordinates and the predicted size.

In some embodiments, as shown in FIG. 15, when coordinates (x, y) of a point in an upper left corner of a palm bounding box 1501 are the predicted coordinates and a width and a height of the palm bounding box 1501 is the predicted size, coordinates of the palm center of the palm (namely, a center point of the palm box) may be represented as (x+w/2, y+h/2).

2. An offset between the palm center and an image center of the current frame of image is determined based on the palm center and the image center.

The offset includes an offset dx in an x direction and an offset dy in a y direction. For example, as shown in FIG. 15, a center point (W/2, H/2) of the current frame of image is used as an origin of coordinates, where W and H are a width and a height of the image respectively. A horizontal rightward direction is a positive direction of an x-axis, and a vertical downward direction is a positive direction of a y-axis. In this case, an offset of the palm center relative to the origin of coordinates is as follows: dx=x+w/2−W/2, and dy=y+h/2−H/2.

3. A target quadrant corresponding to the palm in a coordinate system with the detection device as an origin is determined based on the offset.

Usually, the distance between the palm and the detection device may be obtained by calculating an average value of distance information corresponding to all distance sensors (when a distance sensor is not blocked by any object, the distance sensor measures and returns a specific distance, whether distance information is valid may be determined to eliminate invalid distance information, and then the average value is calculated). However, in an actual case, due to blocking by an arm of the user or the like, the distance sensor may detect incorrect distance information due to the blocking by the arm, and consequently, interference is caused to distance data. In this embodiment of this application, incorrect distance information can be eliminated by using the target quadrant corresponding to the palm, so that accuracy of distance data is improved.

For example, first, a coordinate system is constructed with the camera corresponding to the detection device as an origin. For example, as shown in FIG. 11, a coordinate system is constructed with the camera 1101 as an origin. A target quadrant corresponding to the palm in the coordinate system with the camera as the origin may be determined based on a location of the current frame of image relative to the camera 1101 and an offset vector between a palm center corresponding to the palm bounding box 1103 and the image center. A coordinate system based on the current frame of image and the coordinate system based on the camera are located on a same plane.

In some embodiments, a quadrant corresponding to the palm center in the current frame of image may be determined based on sign information (for example, positive or negative) corresponding to the offset vector, and the quadrant is determined as the target quadrant.

4. A distance sensor in the target quadrant and a distance sensor on a coordinate axis corresponding to the target quadrant are determined as the target distance sensor.

Step 1004: Obtain the distance between the palm and the detection device based on distance information corresponding to the target distance sensor.

In some embodiments, distance information corresponding to the target distance sensor may be averaged to obtain the distance between the palm and the detection device. This can prevent incorrect distance information from being considered during distance calculation due to blocking by an arm, and therefore improve accuracy of obtaining the distance.

In some embodiments, after the distance between the palm and the detection device is obtained, the distance may be physically mapped to a movable element.

In an example, a display location of the movable element in a moving region is positively correlated with the distance. For example, the relationship may be expressed as follows: a display location ratio of the movable element in the moving region is set to 1 when the distance between the palm and the detection device is greater than a first distance threshold; or a display location ratio of the movable element in the moving region is determined based on a ratio of the distance between the palm and the detection device to the first distance threshold when the distance between the palm and the detection device is less than or equal to the first distance threshold.

The first distance threshold may be set and adjusted based on an empirical value, for example, may be 400 mm, 500 mm, or 600 mm. The display location ratio is used for indicating the display location of the movable element in the moving region. The display location ratio being 1 indicates that the movable element is located at a maximum value in the moving region.

For example, the display location ratio may be expressed by the following formula:

$$f = \{ \begin{matrix}P / 500 & P ⩽ 500 \\ 1 & P > 500\end{matrix}$$

P represents the distance between the palm and the detection device, in mm. f is the display location ratio, and is used for representing a distance between the movable element and the bottom of the moving region. In a case that the distance is greater than 500 mm, the display location ratio corresponding to the movable element is 1, which means that a ball corresponding to the movable element is located at the top of a corresponding region. In a case that the distance is less than 500 mm, for example, is 50 mm, the display location ratio corresponding to the movable element is 0.1. To be specific, a distance between the display location of the movable element and the bottom of the moving region is 10% of the moving region.

In an example, a process of determining an initial display location of the movable element may be as follows: An initial relative location between the palm and the detection device is obtained, and an initial display location of the movable element in the moving region is determined based on the initial relative location. For example, the initial display location of the movable element is determined by using the foregoing method for obtaining the display location ratio.

In this case, when detecting that the initial display location of the movable element overlaps a display location of a marked element in the moving region, a location of the marked element is adjusted to obtain an adjusted marked element, the adjusted marked element being used for guiding the movable element to move. For example, the location of the marked element is adjusted, and the user is guided, based on the adjusted marked element, to adjust the distance between the palm and the detection device, to capture local feature information and overall feature information of the palm. The overall feature information and the local feature information of the palm are combined to complete palm verification. This improves security of palm verification.

Alternatively, the display location of the movable element in the moving region is initialized to obtain an initial display location of the movable element, and mapping and association are performed between the initial display location and an initial relative location between the palm and the detection device. For example, the initial display location of the movable element is fixed, and after the initial relative location between the palm and the detection device is obtained, the display location of the marked element is determined to implement guidance for palm verification.

The initial relative location between the palm and the detection device is determined based on a relationship between the initial display location of the movable element and the display location of the marked element, to perform guidance for palm verification and improve accuracy of guidance for palm verification.

To sum up, in the technical solution provided in this embodiment of this application, the distance between the palm and the detection device is indicated by the display location of the movable element in the moving region, and the display location of the movable element in the moving region is dynamically adjusted on the guidance interface in response to a change of the distance. In this way, visual guidance for palm verification can be completed based only on the distance between the palm and the detection device. This reduces complexity of palm verification and therefore improves efficiency of palm verification.

In addition, in this embodiment of this application, the user only needs to be guided to adjust the distance between the palm and the detection device. This reduces costs of understanding by the user during palm verification, and therefore improves user experience during palm verification.

In addition, in this embodiment of this application, a distance estimation method based on palm location detection and the distance sensor is used to improve accuracy of measurement on the palm swipe distance, to improve accuracy of guidance for palm verification.

The following describes apparatus embodiments of this application, which may be used for performing the method embodiments of this application. For details not disclosed in the apparatus embodiments of this application, refer to the method embodiments of this application.

FIG. 16 is a block diagram of a guiding apparatus for palm verification according to an embodiment of this application. The apparatus may be configured to implement the foregoing method for guiding palm verification. The apparatus 1600 may include a guidance interface display module 1601, a guidance information display module 1602, an element location adjustment module 1603, and a prompt information display module 1604.

The guidance interface display module 1601 is configured to display a guidance interface for palm verification.

The guidance information display module 1602 is configured to display graphical guidance information on the guidance interface, the graphical guidance information including a movable element and a moving region corresponding to the movable element, and a display location of the movable element in the moving region being used for indicating a distance between a palm and a detection device.

The element location adjustment module 1603 is configured to dynamically adjust the display location of the movable element in the moving region on the guidance interface in response to a change of the distance.

The prompt information display module 1604 is configured to display first prompt information for indicating starting of verification or completion of verification when the display location of the movable element in the moving region meets a preset condition.

In an exemplary embodiment, the graphical guidance information further includes a marked element displayed in the moving region, a display location of the marked element in the moving region being used for indicating a target distance or a target distance range between the palm and the detection device; and
the prompt information display module 1604 is configured to display the first prompt information for indicating starting of verification or completion of verification when the display location of the movable element in the moving region matches the display location of the marked element in the moving region.

In an exemplary embodiment, there are a plurality of marked elements, and different marked elements correspond to different target distances or target distance ranges; and
the prompt information display module 1604 is further configured to display the first prompt information for indicating starting of verification or completion of verification when the display location of the movable element in the moving region matches display locations of the plurality of marked elements in the moving region in a target order, the target order being a matching order of the plurality of marked elements.

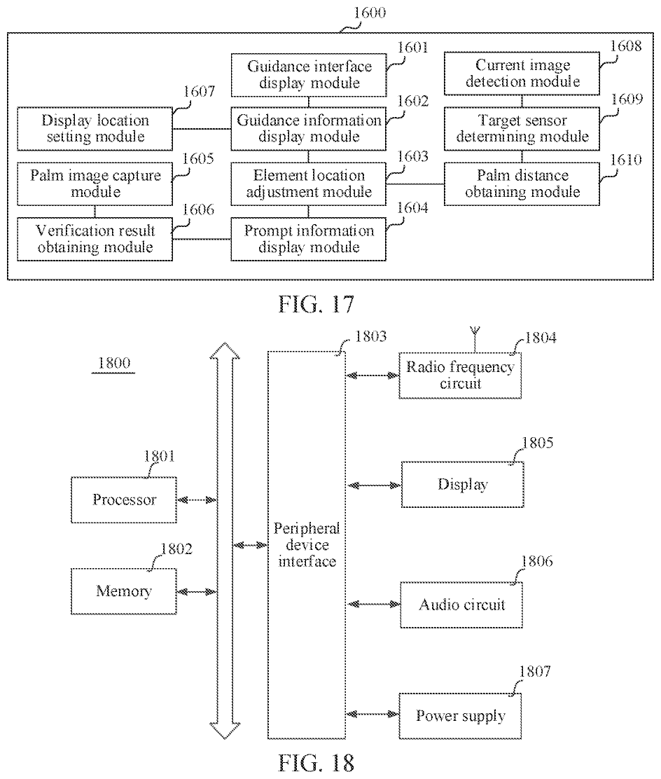

In an exemplary embodiment, prompt information related to the target order is displayed on the guidance interface. As shown in FIG. 17, the apparatus 1600 further includes a palm image capture module 1605 and a verification result obtaining module 1606.

The palm image capture module 1605 is configured to capture an image of the palm by using a camera of the detection device when the movable element matches each marked element.

The verification result obtaining module 1606 is configured to recognize and verify the palm based on a plurality of images of the palm that are captured at different distances to obtain a verification result.

In an exemplary embodiment, no prompt information related to the target order is displayed on the guidance interface;
the prompt information display module 1604 is further configured to display first prompt information for indicating starting of verification when the display location of the movable element in the moving region matches the display locations of the plurality of marked elements in the moving region in the target order; the palm image capture module 1605 is further configured to capture an image of the palm by using a camera of the detection device; and the verification result obtaining module 1606 is further configured to recognize and verify the palm based on the image of the palm to obtain a verification result; or
the prompt information display module 1604 is further configured to display first prompt information for indicating completion of verification when the display location of the movable element in the moving region matches the display locations of the plurality of marked elements in the moving region in the target order.

In an exemplary embodiment, the prompt information display module 1604 is further configured to display, on the guidance interface, second prompt information for guiding a user to perform an operation that needs to be performed.

In an exemplary embodiment, a display screen of the guidance interface does not overlap a palm detection plane of the detection device.

In an exemplary embodiment, the detection device is configured to detect the palm in a contactless manner, and the contactless manner means that the palm is not in contact with a palm detection plane of the detection device.

In an exemplary embodiment, the palm verification includes first-stage verification and second-stage verification, the stage of first-stage verification is completed by a first palm of the user, the stage of second-stage verification is completed by a second palm of the user, and the first palm is different from the second palm; and
the movable element moves along a first specified track by following a distance between the first palm and the detection device to complete the first-stage verification, and the movable element moves along a second specified track by following a distance between the second palm and the detection device to complete the second-stage verification.

In an exemplary embodiment, as shown in FIG. 17, the apparatus 1600 further includes a display location setting module 1607.

The display location setting module 1607 is configured to set a display location ratio of the movable element in the moving region to 1 when the distance between the palm and the detection device is greater than a first distance threshold.

The display location setting module 1607 is further configured to determine a display location ratio of the movable element in the moving region based on a ratio of the distance between the palm and the detection device to the first distance threshold when the distance between the palm and the detection device is less than or equal to the first distance threshold.

In an exemplary embodiment, the display location setting module 1607 is further configured to:
obtain an initial relative location between the palm and the detection device, and determine an initial display location of the movable element in the moving region based on the initial relative location; or
initialize the display location of the movable element in the moving region to obtain an initial display location of the movable element, and perform mapping and association between the initial display location and an initial relative location between the palm and the detection device.

In an exemplary embodiment, the display location setting module 1607 is further configured to: when detecting that the initial display location of the movable element overlaps a display location of a marked element in the moving region, adjust a location of the marked element to obtain an adjusted marked element, the adjusted marked element being used for guiding the movable element to move.

In an exemplary embodiment, as shown in FIG. 17, the apparatus 1600 further includes a current image detection module 1608, a target sensor determining module 1609, and a palm distance obtaining module 1610.

The palm image capture module 1605 is further configured to capture a current frame of image of the palm by using a camera of the detection device.

The current image detection module 1608 is configured to perform palm detection on the current frame of image to obtain predicted coordinates and a predicted size that correspond to the palm.

The target sensor determining module 1609 is configured to determine a target distance sensor from a plurality of distance sensors corresponding to the detection device based on the predicted coordinates and the predicted size.

The palm distance obtaining module 1610 is configured to obtain the distance between the palm and the detection device based on distance information corresponding to the target distance sensor.

In an exemplary embodiment, the target sensor determining module 1609 is configured to:
determine a palm center of the palm based on the predicted coordinates and the predicted size;
determine an offset between the palm center and an image center of the current frame of image based on the palm center and the image center;
determine, based on the offset, a target quadrant corresponding to the palm in a coordinate system with the detection device as an origin; and
determine a distance sensor in the target quadrant and a distance sensor on a coordinate axis corresponding to the target quadrant as the target distance sensor.

In an exemplary embodiment, the prompt information display module 1604 is further configured to display third prompt information in response to that the palm moves out of a verification region corresponding to the detection device, the third prompt information being used for prompting a user to perform palm verification again.

To sum up, in the technical solution provided in this embodiment of this application, the distance between the palm and the detection device is indicated by the display location of the movable element in the moving region, and the display location of the movable element in the moving region is dynamically adjusted on the guidance interface in response to a change of the distance. In this way, visual guidance for palm verification can be completed based only on the distance between the palm and the detection device. This reduces complexity of palm verification and therefore improves efficiency of palm verification.

In addition, in this embodiment of this application, the user only needs to be guided to adjust the distance between the palm and the detection device. This reduces costs of understanding by the user during palm verification, and therefore improves user experience during palm verification.

In a case that the apparatus provided in the foregoing embodiment implements functions of the apparatus, the division of the foregoing functional modules is merely used as an example for description. In practical application, the functions may be allocated to and completed by different functional modules according to requirements. That is, an internal structure of a device is divided into different functional modules to complete all or some of the functions described above. In addition, the apparatus provided in the foregoing embodiment and the method embodiments belong to the same concept. For details about a specific implementation process of the apparatus, refer to the method embodiments. Details are not described herein again.

FIG. 18 is a schematic structural diagram of a terminal device according to an embodiment of this application. The terminal device may be any electronic device with data computing, processing, and storage functions. The terminal device is configured to implement the method for guiding palm verification provided in the foregoing embodiments. The terminal device may be the terminal device 10 in the implementation environment shown in FIG. 1. Details are as follows:

Usually, the terminal device 1800 includes a processor 1801 and a memory 1802.

In some embodiments, the processor 1801 may include one or more processing cores, for example, a 4-core processor or an 8-core processor. The processor 1801 may be implemented in at least one hardware form of a digital signal processor (DSP), a field-programmable gate array (FPGA), and a programmable logic array (PLA). The processor 1801 may also include a main processor and a coprocessor. The main processor is a processor configured to process data in an awake state, and is also referred to as a central processing unit (CPU). The coprocessor is a low-power processor configured to process data in a standby state. In some embodiments, the processor 1801 may be integrated with a graphics processing unit (GPU). The GPU is configured to render and draw content that needs to be displayed on a display screen. In some embodiments, the processor 1801 may further include an artificial intelligence (AI) processor. The AI processor is configured to process computing operations related to machine learning.

In some embodiments, the memory 1802 may include one or more computer-readable storage media. The computer-readable storage medium may be non-transient. The memory 1802 may further include a high-speed random access memory and a nonvolatile memory, for example, one or more disk storage devices or flash storage devices. In some embodiments, the non-transient computer-readable storage medium in the memory 1802 is configured to store a computer program, and the computer program is configured to be executed by one or more processors to implement the foregoing method for guiding palm verification.

In some embodiments, the terminal device 1800 further includes a peripheral device interface 1803 and at least one peripheral device. The processor 1801, the memory 1802, and the peripheral device interface 1803 may be connected through a bus or a signal cable. Each peripheral device may be connected to the peripheral device interface 1803 through a bus, a signal cable, or a circuit board. Specifically, the peripheral device includes at least one of a radio frequency circuit 1804, a display screen 1805, an audio circuit 1806, and a power supply 1807.

A person skilled in the art may understand that the structure shown in FIG. 18 constitutes no limitation on the terminal device 1800, and the terminal device may include more or fewer components than those shown in the figure, or some components may be combined, or a different component layout may be used.

In an exemplary embodiment, a computer-readable storage medium is further provided, the storage medium storing a computer program, and the computer program being executed by a processor to implement the foregoing method for guiding palm verification.

In some embodiments, the computer-readable storage medium may include a read-only memory (ROM), a random access memory (RAM), a solid state drive (SSD), an optical disc, or the like. The RAM may include a resistance random access memory (ReRAM) and a dynamic random access memory (DRAM).

In an exemplary embodiment, a computer program product is further provided, the computer program product including a computer program, and the computer program being stored in a computer-readable storage medium. A processor of a terminal device reads the computer program from the computer-readable storage medium, and the processor executes the computer program, so that the terminal device performs the foregoing method for guiding palm verification.

In some embodiments, this application further includes the following content:

1. A method for guiding palm verification, the method being performed by a terminal device, and the method comprising:
displaying a guidance interface for palm verification;
displaying graphical guidance information on the guidance interface, the graphical guidance information comprising a movable element and a moving region corresponding to the movable element, and a display location of the movable element in the moving region being used for indicating a distance between a palm and a detection device;
dynamically adjusting the display location of the movable element in the moving region on the guidance interface in response to a change of the distance; and
displaying first prompt information for indicating starting of verification or completion of verification when the display location of the movable element in the moving region meets a preset condition.

2. The method according to claim 1, wherein the graphical guidance information further comprises a marked element displayed in the moving region, a display location of the marked element in the moving region being used for indicating a target distance or a target distance range between the palm and the detection device; and
the displaying first prompt information for indicating starting of verification or completion of verification when the display location of the movable element in the moving region meets a preset condition comprises:
displaying the first prompt information for indicating starting of verification or completion of verification when the display location of the movable element in the moving region matches the display location of the marked element in the moving region.

3. The method according to claim 2, wherein there are a plurality of marked elements, and different marked elements correspond to different target distances or target distance ranges; and
the displaying first prompt information for indicating starting of verification or completion of verification when the display location of the movable element in the moving region matches the display location of the marked element in the moving region comprises:
displaying the first prompt information for indicating starting of verification or completion of verification when the display location of the movable element in the moving region matches display locations of the plurality of marked elements in the moving region in a target order,
the target order being a matching order of the plurality of marked elements.

4. The method according to claim 3, wherein prompt information related to the target order is displayed on the guidance interface; and
the method further comprises:
capturing an image of the palm by using a camera of the detection device when the movable element matches each marked element; and
recognizing and verifying the palm based on a plurality of images of the palm that are captured at different distances to obtain a verification result.

5. The method according to claim 3, wherein no prompt information related to the target order is displayed on the guidance interface; and
the displaying first prompt information for indicating starting of verification or completion of verification when the display location of the movable element in the moving region matches display locations of the plurality of marked elements in the moving region in a target order comprises:
displaying first prompt information for indicating starting of verification when the display location of the movable element in the moving region matches the display locations of the plurality of marked elements in the moving region in the target order; capturing an image of the palm by using a camera of the detection device; and recognizing and verifying the palm based on the image of the palm to obtain a verification result;
or
displaying first prompt information for indicating completion of verification when the display location of the movable element in the moving region matches the display locations of the plurality of marked elements in the moving region in the target order.

6. The method according to any one of claims 1 to 5, wherein the method further comprises:
displaying, on the guidance interface, second prompt information for guiding a user to perform an operation that needs to be performed.

7. The method according to any one of claims 1 to 6, wherein a display screen of the guidance interface does not overlap a palm detection plane of the detection device.

8. The method according to any one of claims 1 to 7, wherein the detection device is configured to detect the palm in a contactless manner, and the contactless manner means that the palm is not in contact with a palm detection plane of the detection device.

9. The method according to any one of claims 1 to 8, wherein the method further comprises:
setting a display location ratio of the movable element in the moving region to 1 when the distance between the palm and the detection device is greater than a first distance threshold; or
determining a display location ratio of the movable element in the moving region based on a ratio of the distance between the palm and the detection device to the first distance threshold when the distance between the palm and the detection device is less than or equal to the first distance threshold.

10. The method according to any one of claims 1 to 9, wherein the method further comprises:
obtaining an initial relative location between the palm and the detection device, and determining an initial display location of the movable element in the moving region based on the initial relative location;
or
initializing the display location of the movable element in the moving region to obtain an initial display location of the movable element, and performing mapping and association between the initial display location and an initial relative location between the palm and the detection device.

11. The method according to claim 10, wherein the method further comprises:
when detecting that the initial display location of the movable element overlaps a display location of a marked element in the moving region, adjusting a location of the marked element to obtain an adjusted marked element, the adjusted marked element being used for guiding the movable element to move.

12. The method according to any one of claims 1 to 11, wherein the method further comprises:
capturing a current frame of image of the palm by using a camera of the detection device;
performing palm detection on the current frame of image to obtain predicted coordinates and a predicted size that correspond to the palm;
determining a target distance sensor from a plurality of distance sensors corresponding to the detection device based on the predicted coordinates and the predicted size; and
obtaining the distance between the palm and the detection device based on distance information corresponding to the target distance sensor.

13. The method according to claim 12, wherein the determining a target distance sensor from a plurality of distance sensors corresponding to the detection device based on the predicted coordinates and the predicted size comprises:
determining a palm center of the palm based on the predicted coordinates and the predicted size;
determining an offset between the palm center and an image center of the current frame of image based on the palm center and the image center;
determining, based on the offset, a target quadrant corresponding to the palm in a coordinate system with the detection device as an origin; and
determining a distance sensor in the target quadrant and a distance sensor on a coordinate axis corresponding to the target quadrant as the target distance sensor.

14. The method according to any one of claims 1 to 13, wherein the method further comprises:
displaying third prompt information in response to that the palm moves out of a verification region corresponding to the detection device, the third prompt information being used for prompting a user to perform palm verification again.

15. A guiding apparatus for palm verification, the apparatus comprising:
a guidance interface display module, configured to display a guidance interface for palm verification;
a guidance information display module, configured to display graphical guidance information on the guidance interface, the graphical guidance information comprising a movable element and a moving region corresponding to the movable element, and a display location of the movable element in the moving region being used for indicating a distance between a palm and a detection device;
an element location adjustment module, configured to dynamically adjust the display location of the movable element in the moving region on the guidance interface in response to a change of the distance; and
a prompt information display module, configured to display first prompt information for indicating starting of verification or completion of verification when the display location of the movable element in the moving region meets a preset condition.

16. A terminal device, the terminal device comprising a processor and a memory, the memory storing a computer program, and the computer program being loaded and executed by the processor to implement the method for guiding palm verification according to any one of claims 1 to 14.

17. A computer-readable storage medium, the computer-readable storage medium storing a computer program, and the computer program being loaded and executed by a processor to implement the method for guiding palm verification according to any one of claims 1 to 14.

18. A computer program product, the computer program product comprising a computer program, the computer program being stored in a computer-readable storage medium, and a processor reading the computer program from the computer-readable storage medium and executing the computer program to implement the method for guiding palm verification according to any one of claims 1 to 14.

In this application, a palm (or another biological feature) recognition technology is used. In a case that the foregoing embodiments of this application are applied to a specific product or technology, related data collection, use, and processing processes shall comply with requirements of national laws and regulations. Before palm information is collected, a target object shall be informed of information processing rules, and individual consent (alternatively with a legal basis) shall be obtained from the target object. In addition, the palm information is processed in strict compliance with requirements of laws and regulations and personal information processing rules, and technical measures are taken to ensure security of related data.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules or units. Moreover, each module can be part of an overall module that includes the functionalities of the module. “Plurality” mentioned in this specification means two or more. “And/or” describes an association relationship between associated objects and indicates that three relationships may exist. For example, A and/or B may indicate the following three cases: the following three cases: Only A exists, both A and B exist, and only B exists. The character “/” usually indicates an “or” relationship between the associated objects. In addition, the step numbers described in this specification merely exemplarily show a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited in the embodiments of this application.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for guiding palm verification performed by a terminal device, and the method comprising:
displaying a guidance interface for palm verification, the guidance interface including graphical guidance information and the graphical guidance information comprising a movable element in a moving region, and a display location of the movable element in the moving region indicating a current distance between a palm and a detection device;
dynamically adjusting the display location of the movable element in the moving region on the guidance interface in response to a change of the current distance between the palm and the detection device; and
displaying first prompt information for indicating starting of verification or completion of verification when the display location of the movable element in the moving region meets a preset condition.

2. The method according to claim 1, wherein the preset condition is met when the display location of the movable element in the moving region matches a display location of a marked element in the moving region, the display location of the marked element in the moving region indicating a target distance or a target distance range between the palm and the detection device.

3. The method according to claim 1, wherein the method further comprises:
capturing an image of the palm by using a camera of the detection device when the movable element meets the predefined condition; and
recognizing and verifying the palm in the image based on a plurality of images of the palm that are captured at different distances to obtain a verification result.

4. The method according to claim 1, wherein there are a plurality of marked elements, and different marked elements correspond to different target distances or target distance ranges; and
the displaying first prompt information for indicating starting of verification or completion of verification when the display location of the movable element in the moving region meets a preset condition comprises:
displaying first prompt information for indicating starting of verification when the display location of the movable element in the moving region matches the display locations of the plurality of marked elements in the moving region in a target order; capturing an image of the palm by using a camera of the detection device; and recognizing and verifying the palm based on the image of the palm to obtain a verification result.

5. The method according to claim 1, wherein the method further comprises:
displaying, on the guidance interface, second prompt information for guiding a user to perform an operation in accordance with the current distance between the palm and the detection device.

6. The method according to claim 1, wherein a display screen of the guidance interface does not overlap a palm detection plane of the detection device.

7. The method according to claim 1, wherein the method further comprises:
setting a display location ratio of the movable element in the moving region to 1 when the distance between the palm and the detection device is greater than a first distance threshold; and
determining a display location ratio of the movable element in the moving region based on a ratio of the distance between the palm and the detection device to the first distance threshold when the distance between the palm and the detection device is less than or equal to the first distance threshold.

8. The method according to claim 1, wherein the method further comprises:
capturing a current frame of image of the palm by using a camera of the detection device;
performing palm detection on the current frame of image to obtain predicted coordinates and a predicted size that correspond to the palm;
determining a target distance sensor from a plurality of distance sensors corresponding to the detection device based on the predicted coordinates and the predicted size; and
obtaining the current distance between the palm and the detection device based on distance information corresponding to the target distance sensor.

9. The method according to claim 8, wherein the determining a target distance sensor from a plurality of distance sensors corresponding to the detection device based on the predicted coordinates and the predicted size comprises:
determining a palm center of the palm based on the predicted coordinates and the predicted size;
determining an offset between the palm center and an image center of the current frame of image based on the palm center and the image center;
determining, based on the offset, a target quadrant corresponding to the palm in a coordinate system with the detection device as an origin; and
determining a distance sensor in the target quadrant and a distance sensor on a coordinate axis corresponding to the target quadrant as the target distance sensor.

10. A computer device comprising a processor and a memory, the memory storing a computer program, and the computer program being loaded and executed by the processor to cause the computer device to implement a method for guiding palm verification including:
displaying a guidance interface for palm verification, the guidance interface including graphical guidance information and the graphical guidance information comprising a movable element in a moving region, and a display location of the movable element in the moving region indicating a current distance between a palm and a detection device;
dynamically adjusting the display location of the movable element in the moving region on the guidance interface in response to a change of the current distance between the palm and the detection device; and
displaying first prompt information for indicating starting of verification or completion of verification when the display location of the movable element in the moving region meets a preset condition.

11. The computer device according to claim 10, wherein the preset condition is met when the display location of the movable element in the moving region matches a display location of a marked element in the moving region, the display location of the marked element in the moving region indicating a target distance or a target distance range between the palm and the detection device.

12. The computer device according to claim 10, wherein the method further comprises:
capturing an image of the palm by using a camera of the detection device when the movable element meets the predefined condition; and
recognizing and verifying the palm in the image based on a plurality of images of the palm that are captured at different distances to obtain a verification result.

13. The computer device according to claim 10, wherein there are a plurality of marked elements, and different marked elements correspond to different target distances or target distance ranges; and
the displaying first prompt information for indicating starting of verification or completion of verification when the display location of the movable element in the moving region meets a preset condition comprises:
displaying first prompt information for indicating starting of verification when the display location of the movable element in the moving region matches the display locations of the plurality of marked elements in the moving region in a target order; capturing an image of the palm by using a camera of the detection device; and recognizing and verifying the palm based on the image of the palm to obtain a verification result.

14. The computer device according to claim 10, wherein the method further comprises:
displaying, on the guidance interface, second prompt information for guiding a user to perform an operation in accordance with the current distance between the palm and the detection device.

15. The computer device according to claim 10, wherein a display screen of the guidance interface does not overlap a palm detection plane of the detection device.

16. The computer device according to claim 10, wherein the method further comprises:
setting a display location ratio of the movable element in the moving region to 1 when the distance between the palm and the detection device is greater than a first distance threshold; and
determining a display location ratio of the movable element in the moving region based on a ratio of the distance between the palm and the detection device to the first distance threshold when the distance between the palm and the detection device is less than or equal to the first distance threshold.

17. The computer device according to claim 10, wherein the method further comprises:
capturing a current frame of image of the palm by using a camera of the detection device;
performing palm detection on the current frame of image to obtain predicted coordinates and a predicted size that correspond to the palm;
determining a target distance sensor from a plurality of distance sensors corresponding to the detection device based on the predicted coordinates and the predicted size; and
obtaining the current distance between the palm and the detection device based on distance information corresponding to the target distance sensor.

18. The computer device according to claim 17, wherein the determining a target distance sensor from a plurality of distance sensors corresponding to the detection device based on the predicted coordinates and the predicted size comprises:
determining a palm center of the palm based on the predicted coordinates and the predicted size;
determining an offset between the palm center and an image center of the current frame of image based on the palm center and the image center;
determining, based on the offset, a target quadrant corresponding to the palm in a coordinate system with the detection device as an origin; and
determining a distance sensor in the target quadrant and a distance sensor on a coordinate axis corresponding to the target quadrant as the target distance sensor.

19. A non-transitory computer-readable storage medium storing a computer program, and the computer program being loaded and executed by a processor of a computer device to cause the computer device to implement a method for guiding palm verification including:
displaying a guidance interface for palm verification, the guidance interface including graphical guidance information and the graphical guidance information comprising a movable element in a moving region, and a display location of the movable element in the moving region indicating a current distance between a palm and a detection device;
dynamically adjusting the display location of the movable element in the moving region on the guidance interface in response to a change of the current distance between the palm and the detection device; and
displaying first prompt information for indicating starting of verification or completion of verification when the display location of the movable element in the moving region meets a preset condition.

20. The non-transitory computer-readable storage medium according to claim 19, wherein the method further comprises:
capturing a current frame of image of the palm by using a camera of the detection device;
performing palm detection on the current frame of image to obtain predicted coordinates and a predicted size that correspond to the palm;
determining a target distance sensor from a plurality of distance sensors corresponding to the detection device based on the predicted coordinates and the predicted size; and
obtaining the current distance between the palm and the detection device based on distance information corresponding to the target distance sensor.
